(19) United States
(12) Patent Application Publication
(10) Pub. No.: US 2021/0106962 A1
(43) Pub. Date: Apr. 15, 2021

(54) FLOW REACTOR AND FLOW REACTOR ASSEMBLY, AND USE OF A PRESSURIZING MEDIUM

(71) Applicant: IKA-Werke GmbH & Co. KG, Staufen (DE)

(72) Inventors: Stephen Hilton, Kent (GB); Dirk Waldmann, Staufen (DE)

(21) Appl. No.: 17/065,996

(22) Filed: Oct. 8, 2020

(30) Foreign Application Priority Data
Oct. 11, 2019 (DE) 102019127459.1

(51) Int. Cl. B01J 4/00; B01J 19/24

(52) U.S. Cl. CPC B01J 4/001; B01J 2204/002; B01J 4/008; B01J 19/24

(57) ABSTRACT

The invention relates to improvements in the technical field of flow reactors. To this end, a flow reactor which has a pressure connector is inter alia proposed. An internal volume of the flow reactor is able to be impinged with pressure by way of the pressure connector in order for a flow through the flow reactor to be generated. Compressed air and/or an inert gas such as, for example, nitrogen and/or argon, is preferably used to this end.

### FIELD OF THE INVENTION

The invention relates to a flow reactor, to a flow reactor assembly, and to the use of a pressurizing medium for generating a flow through a flow reactor.

### BACKGROUND OF THE INVENTION

Flow reactors in various embodiments are known from the prior art and in practice. Said flow reactors are used in so-called flow chemistry in order for reaction products to be produced from primary materials.

In the flow reactors known from the prior art comparatively complex pumps are used in order for a flow through the flow reactors to be generated. These pumps are typically very precise but therefore also comparatively expensive. It is not necessary for precise pumps of this type to be used in all applications. Only a fraction of the functions made available by flow reactors of this type are often required.

Furthermore, flow reactors of this type by virtue of the technical complexity thereof are not only expensive in terms of procurement but moreover also complex in terms of servicing and maintenance. Furthermore, said flow reactors are often comparatively complicated in terms of operation and uncomfortable in terms of their handling.

### SUMMARY OF THE INVENTION

It is an object of the invention to provide a flow reactor of the type mentioned at the outset which is of a simpler construction and therefore is easier to operate.

In order for this object to be achieved, a flow reactor of the type mentioned at the outset which has the means and features of the independent claim directed toward a flow reactor of this type is proposed. A flow reactor with a pressure connector by way of which an internal volume of the flow reactor is able to be impinged with pressure in order for a flow through a reaction chamber of the flow reactor to be generated is thus in particular proposed in order for the object to be achieved.

Instead of a comparatively complex and expensive pump, the flow reactor according to the invention by way of the pressure connector thereof can be supplied with and pressurized by a pressurizing medium, for example, which is then used as a conveying medium. The flow through the flow reactor, and here in particular through the reaction chamber of the flow reactor, can be caused by way of a pressure differential between the internal volume of the flow reactor and an environment in which the flow reactor is operated. A separate pump is not required to this end.

In one embodiment of the flow reactor it is provided that said flow reactor has a receptacle vessel for a primary material, the receptacle volume of said receptacle vessel, as internal volume of the flow reactor, by way of the pressure connector being able to be impinged with pressure in order for the flow through the reaction chamber of the flow reactor to be generated. The receptacle vessel can be used for receiving a primary material, for example a primary liquid. The primary liquid can be conveyed as a reactant or else as a simple vehicle through the flow reactor and in particular through the reaction chamber thereof. As has already been explained above, the receptacle volume of the receptacle vessel to this end can be impinged with pressure by way of the pressure connector of the flow reactor. It is thus possible for a primary material which is situated within the receptacle vessel to be discharged from the receptacle vessel and the receptacle volume of the latter into and through the reaction chamber of the flow reactor. The receptacle volume of the receptacle vessel can be connected to the reaction chamber of the flow reactor by way of a line in order for the primary material from the receptacle vessel to be supplied to the reaction chamber of the flow reactor.

In one advantageous embodiment of the flow reactor it is provided that the pressure connector is configured on the receptacle vessel, for example on a closure cap of the receptacle vessel. The receptacle vessel can thus be pressurized by way of the pressure connector for conveying the primary material out of the receptacle volume of the receptacle vessel.

In the simplest case, the receptacle vessel can be configured as a receptacle bottle which is provided with a lid or a closure cap. The receptacle bottle can furthermore be configured as a pressure cylinder.

The flow reactor can have at least one flow cell. The flow cell can be connected at least indirectly to the receptacle volume of the receptacle vessel. The initial material or materials can flow through the flow cell during the operation of the flow reactor. At least part of the reaction chamber of the flow reactor can be configured within the at least one flow cell of the flow reactor. In particular when the flow reactor has more than only one flow cell, it can be expedient for the flow reactor to comprise a holder for at least one flow cell, preferably for a plurality of flow cells.

A pressurizing medium, in particular a pressurizing gas, particularly preferably compressed air and/or an inert gas such as, for example, nitrogen and/or argon, can be introduced into the interior volume of the flow reactor by way of the pressure connector. On account thereof, primary materials and substances, in particular liquids, which are situated within the volume can be conveyed through the flow reactor and the reaction chamber thereof. The use of an inert gas such as, for example, nitrogen and/or argon as a pressurizing gas enables inert reactions to be carried out.

In one particularly preferred embodiment of the flow reactor, the pressure connector can be able to be connected to a pressure source, in particular to a compressed-air source, particularly preferably to a compressed-air connector of a compressed-air network. Compressed-air networks are typically available in every chemical laboratory such that the flow reactor equipped in such a manner can be readily operated in any chemical laboratory without any further drive means or pressure sources.

In one embodiment of the flow reactor it is provided that the receptacle vessel has an immersion pipe which is disposed within the receptacle volume of the receptacle vessel. The primary material can be dispensed from the receptacle vessel and supplied to the reaction chamber of the flow reactor by way of the immersion pipe. The use of an immersion pipe enables the receptacle volume of the receptacle vessel to be emptied almost without waste, since an exit cross section of a discharging line of the flow reactor from the receptacle volume of the receptacle vessel by way of the immersion pipe can be disposed at an ideally deep location of the receptacle volume.

The flow reactor can furthermore have a mixing chamber. A plurality of primary materials and/or additives and/or further substances can be mixed with one another in the mixing chamber. The mixing chamber can be connected to the receptacle volume of the receptacle vessel by way of a line, for example by way of the line already mentioned. It is thus possible for a primary material from the receptacle volume of the receptacle vessel to be conveyed into the mixing chamber.

The flow reactor can have at least one injector which is connected at least indirectly to the reaction chamber of the flow reactor, preferably by way of a mixing chamber, for example by way of the mixing chamber already mentioned above. The at least one injector can have an injector opening or an injection opening by way of which the substances can be introduced at least indirectly into the reaction chamber of the flow reactor.

The flow reactor can furthermore have at least one laboratory apparatus. For example, a heating device, an agitating device, in particular a magnetic agitator, and/or a potentiostat for carrying out electrochemical processes can be provided as a laboratory apparatus. The flow reactor can furthermore have a light source in order to be able to carry out photochemical processes.

The flow reactor can have a collection vessel for a reaction product. The connection vessel can be connected at least indirectly to the reaction chamber of the flow reactor, for example by way of a corresponding line.

The flow reactor can have at least one throttle by way of which the flow rate and/or the flow velocity and/or the flow volume through the flow reactor can be predefined. With the aid of the at least one throttle it is possible for a pressure differential between the internal volume of the flow reactor and a collection vessel of the flow reactor to be set, said internal volume being impinged with pressure by way of the pressure connector of the flow reactor. A capillary resistance can be used as a throttle, for example. The at least one throttle can be provided in a line of the flow reactor. The throttle, in particular the capillary resistance, can be disposed in a line of the flow reactor between the receptacle vessel and the collection vessel already mentioned before for a reaction product of the flow reactor. The at least one throttle, when viewed in the flow direction through the flow reactor, is particularly preferably disposed downstream of the reaction chamber, in particular downstream of the at least one flow cell. Specifically, the at least one throttle can be disposed in a line between the reaction chamber of the flow reactor and the collection vessel for a reaction product of the flow reactor.

The flow reactor can have at least one pressure sensor and/or a pressure regulating device. A pressure which is prevalent within the receptacle volume of the receptacle vessel can be at least indirectly derived by way of the pressure sensor. A pressure with which the internal volume of the flow reactor is to be impinged upon can be predefined by way of the pressure regulating device in order for a defined flow rate to be set.

A flow reactor assembly which comprises the means and features of the independent claim directed to such a flow reactor assembly is also proposed in order for the object to be achieved. A flow reactor assembly which has at least one flow reactor as claimed in one of the claims directed towards such a flow reactor and a pressure source which is connected to the pressure connector of the flow reactor is thus in particular proposed in order for the object to be achieved.

A pressurizing gas source can in particular be used as the pressure source, and particularly preferably a compressed-air source such as, for example, a compressed-air network.

The use of a pressurizing medium as claimed in the independent claim directed toward a use of this type is finally also proposed in order for the object to be achieved. The use of a pressurizing medium, in particular a pressurizing gas, particularly preferably compressed-air and/or an inert gas such as nitrogen and/or argon for generating a flow through a reaction chamber of a flow reactor, in particular such a flow reactor as claimed in one of the claims directed toward a flow reactor, is thus in particular proposed in order for the object to be achieved.

The pressurizing medium herein can be forced into an internal volume of the flow reactor so as to generate a pressure differential between the internal volume and an environment, and on account thereof a flow through the flow reactor.

In one preferred variant of the use, the pressurizing medium is forced into a receptacle volume of a receptacle vessel of the flow reactor for a primary material so as to generate said pressure differential, on account thereof to supply the primary material from the receptacle volume of the receptacle vessel to a reaction chamber of the flow reactor, and thus to cause a flow through the flow reactor.

### BRIEF DESCRIPTION OF THE DRAWING

An exemplary embodiment of the invention will be described in more detail by means of the drawing. It is to be pointed out that the invention is not limited to the exemplary embodiment shown in the figure. Further exemplary embodiments of the invention are derived by combining individual features or a plurality of the features of the claims with one another and/or in combination with the features from the general description and/or the description of the figure. In the single figure, in a highly schematic manner:

FIG. 1 shows a perspective view of a flow reactor, the receptacle vessel of the latter for a primary material having a pressure connector to which a line of a pressure source, here a compressed-air network of a laboratory, is connected in order for a receptacle volume of the receptacle vessel to be impinged upon with pressure and to generate a flow through the flow reactor.

### DETAILED DESCRIPTION

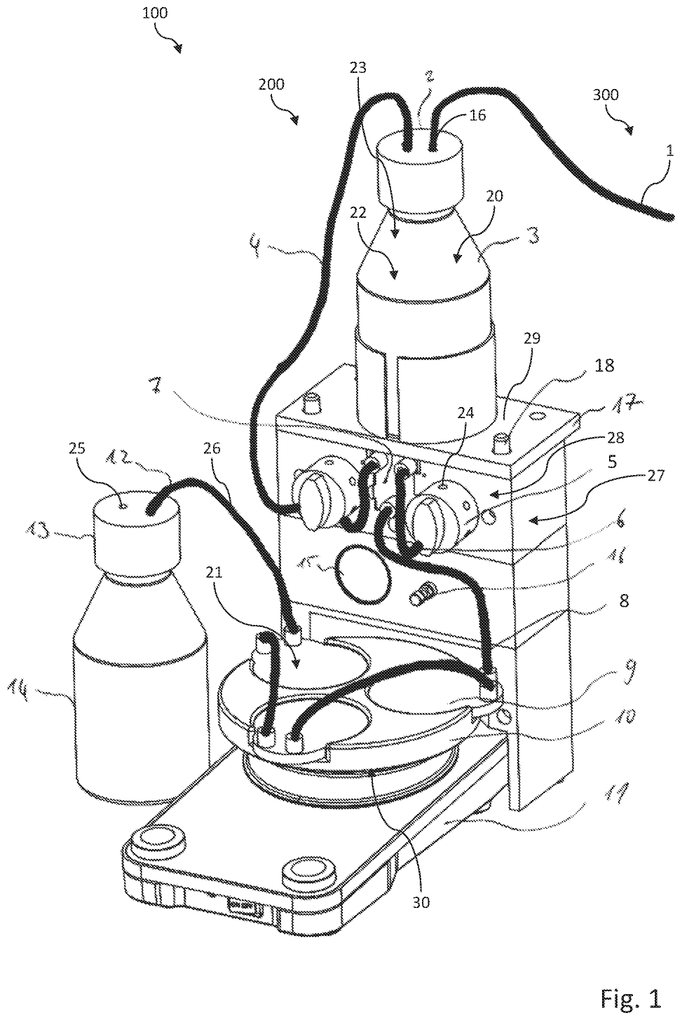

FIG. 1 shows a flow reactor assembly which in its entirety is identified by the reference sign 100, having a flow reactor 200 and a pressure source 300. The pressure source 300 in the exemplary embodiment shown is a compressed-air source as is present in many laboratories.

The pressure source 300 is connected to a pressure connector 19 of the flow reactor 200 by way of a supply line 1 which can also be referred to as a pressure line. An internal volume 20 of the flow reactor 200 by way of the pressure connector 19 can be impinged with a pressure in order for a pressure differential between the internal volume 20 and an environment of the flow reactor 200, and on account thereof of flow through a reaction chamber 21 of the flow reactor 200, to be generated.

The flow reactor 200 has a receptacle vessel 3 in the form of a bottle. The receptacle vessel 3 serves for receiving a primary material which is to be processed by the flow reactor 200. The primary material will typically be present in liquid form. A receptacle volume 22 of the receptacle vessel 3, as the internal volume 20 of the flow reactor 200, is impinged with pressure by way of the pressure connector 19 in order for the flow through the reaction chamber 21 of the flow reactor 200 to be generated. Since the receptacle volume 22 of the receptacle vessel 3 is connected to the reaction chamber 21 by way of a line 4, primary material from the receptacle volume 22 of the receptacle vessel 3, when correspondingly impinging the receptacle volume 22 of the receptacle vessel 3 with pressure in the operation of the flow reactor 200, is discharged into the reaction chamber 21 of the flow reactor 200.

The pressure connector 19 of the flow reactor 200 is configured on the receptacle vessel 3 and here on a closure cap 2 of the receptacle vessel 3. The flow reactor 200 furthermore comprises a total of three flow cells 9 which are connected at least indirectly to the receptacle volume 22 of the receptacle vessel 3, and in which at least part of the reaction chamber 21 of the flow reactor 200 is configured. The primary material and optionally further substances flow through the flow cells 9 in the operation of the flow reactor 200.

In the operation of the flow reactor 200 a pressurizing medium, in particular a pressurizing gas, in the present exemplary embodiment compressed air, is introduced into the internal volume 20 and thus into the receptacle volume 22 of the receptacle vessel 3 of the flow reactor 200 by way of the pressure connector 19. The receptacle volume 22 of the receptacle vessel 3 on account thereof is pressurized such that a pressure differential can be measured between the receptacle volume 22 of the receptacle vessel 3 and the environment, or a collection vessel 14 of the flow reactor 200, respectively, said pressure differential being able to be utilized for generating the flow through the flow reactor 200.

Another pressurizing gas can also be used instead of compressed air. In order for inert reactions to be carried out, it is conceivable for an inert gas such as nitrogen and/or argon to be used as a pressurizing gas, for example.

The pressure connector 19 is connected to a pressure source 300, here a compressed-air source, specifically to a compressed-air connector of a compressed-air network. A compressed-air network such as can be found in many laboratories thus serves as the pressure source 300 in the exemplary embodiment shown of the flow reactor assembly 100.

In order for the receptacle vessel 3 to be able to be emptied ideally without waste, the receptacle vessel 3 can have an immersion pipe 23. The immersion pipe 23 is disposed within the receptacle volume 22 of the receptacle vessel 3 and is connected to the line 4 which leads away from the receptacle vessel 3. With the aid of the immersion pipe 23, a primary material can be conveyed out of the pressurized receptacle vessel 3 of the flow reactor 200.

The flow reactor 200 downstream of the receptacle vessel 3 has a mixing chamber 7. The mixing chamber 7 by way of the line 4 is connected at least indirectly to the receptacle volume 22 of the receptacle vessel 3. The flow reactor 200 furthermore possesses two injectors 5 by way of which further primary materials, preferably in liquid form, can be supplied at least indirectly to the reaction chamber 21 of the flow reactor 200. In the exemplary embodiment shown of the flow reactor 200, the injectors 5 open out into the mixing chamber 7 which has already been mentioned above. In the mixing chamber 7, primary material which has been supplied from the receptacle vessel 3 can mix with further substances which have been introduced by way of the two injectors 5, and can subsequently be supplied to the downstream reaction chamber 21 of the flow reactor 200 by way of the line 8. The injectors 5 are in each case connected to the mixing chamber 7 by way of one line which is identified by the reference sign 6. Each of the injectors 5 has at least one injection opening 24. The injection openings 24 can be utilized for injecting substances into the mixing chamber 7 by way of the injectors 5.

The flow reactor 200 which is shown in the figure furthermore has a laboratory apparatus 11, a holder 10 for the total of three flow cells 9 which are connected to one another by way of lines being disposed on the support surface of said laboratory apparatus 11. The laboratory apparatus 11 is a magnetic agitator which is equipped with a heating device and by way of which substances which are situated in the reaction chamber 21 can be heated and mixed. The flow reactor 200 furthermore has a light source 30 for carrying out photochemical processes.

The primary material and/or the additional substances, from the flow cells 9, in which at least part of the reaction chamber 21 of the flow reactor 1 is configured, reach a collection vessel 14 of the flow reactor 200 by way of a line 12. A reaction product which has been processed by the flow reactor 200 is collected in the collection vessel 14.

The collection vessel 14 has a closure cap 13 to which the line 12 is connected. An equalization of pressure can take place by way of an opening 25 in the closure cap 13 of the collection vessel 14 such that the ambient pressure is substantially prevalent within the collection vessel 14. A pressure differential by way of which a flow through the flow reactor 3 and the lines 4, 6, 8, and 12 of the latter can be generated can thus be measured between the receptacle volume 22 within the receptacle vessel 3 and the interior of the collection vessel 14.

The flow reactor 200 has a throttle 26 in order to control the throughput rate and thus a flow rate through the flow reactor 200. The throttle 26 is formed by a capillary resistance which is disposed in the line 12 of the flow reactor 200 and thus, when viewed in the flow direction, is disposed between the last flow cell 9 and the collection vessel 14 for the reaction product. The flow reactor 200 is equipped with a pressure regulator 16. The currently prevailing pressure is indicated by way of a pressure display 15. The prevailing pressure and thus the flow rate through the flow reactor 200 can be adapted by way of the pressure regulator 16.

Pressure regulating can also be performed when required. For this purpose, the flow reactor 200 has a pressure regulating device 27 as well as at least one pressure sensor 28. A pressure within the internal volume 20 and/or within the reaction chamber 21 and thus a flow rate can thus be regulated.

The flow reactor 22 furthermore has a housing 17. The latter can be constructed in multiple parts which can facilitate simple transportation of the flow reactor 200. An uppermost part of the housing 17 is formed by a holding plate 29 for the receptacle vessel 3 of the flow reactor 300. The holding plate 29 herein is placed onto two holding bars 18 which connect the individual part of the housing 17 to one another.

A pressurizing medium, here compressed air, is used for operating the flow reactor 200 in order to generate the afore-described pressure differential and thus a flow through the reaction chamber 21 of the flow reactor 200. The pressurizing medium, here the compressed air, herein is forced into the receptacle volume 22 of the receptacle vessel 3 of the flow reactor 200, said receptacle volume 22 being utilized for receiving a primary material. On account thereof it is possible for the primary material from the receptacle volume 22 of the receptacle vessel 3 to be supplied to the reaction chamber 21 of the flow reactor 200 and for said primary material from said reaction chamber 21 to be finally conveyed out of the latter into the collection vessel 14.

The invention relates to improvements in the technical field of flow reactors. To this end, a flow reactor 200 which has a pressure connector 19 is inter alia proposed. An internal volume 20 of the flow reactor 200 is able to be impinged with pressure by way of the pressure connector 19 in order for a flow through the flow reactor 200 to be generated. Compressed air and/or an inert gas such as, for example, nitrogen and/or argon, is preferably used to this end.

1. A flow reactor (200) having a pressure connector (19) by way of which an internal volume (20) of the flow reactor (200) is able to be impinged with pressure in order for a flow through a reaction chamber (21) of the flow reactor (200) to be generated.

2. The flow reactor (200) as claimed in claim 1, wherein the flow reactor (200) has a receptacle vessel (3) for a primary material, receptacle volume (22) of said receptacle vessel (3), as the internal volume (20) of the flow reactor (200), by way of the pressure connector (19) being able to be impinged with pressure in order for the flow through the reaction chamber (21) of the flow reactor (200) to be generated.

3. The flow reactor (200) as claimed in claim 2, wherein the receptacle volume (22) of the receptacle vessel (3) is connected to the reaction chamber (21) by way of a line (4).

4. The flow reactor (200) as claimed in claim 2, wherein the pressure connector (19) is configured on the receptacle vessel (3).

5. The flow reactor (200) as claimed in claim 2, wherein the flow reactor (200) has at least one flow cell (9) which is connected at least indirectly to the receptacle volume (22) of the receptacle vessel (3) and in which at least part of the reaction chamber (21) of the flow reactor (200) is configured.

6. The flow reactor (200) as claimed in claim 1, wherein a pressurizing medium is able to be introduced into the internal volume (20) of the flow reactor (200) by way of the pressure connector (19).

7. The flow reactor (200) as claimed in claim 1, wherein the pressure connector (19) is able to be connected to a pressure source for a pressurizing medium.

8. The flow reactor (200) as claimed in claim 2, wherein the receptacle vessel (3) has an immersion pipe (23) which is disposed within the receptacle volume (22) of the receptacle vessel (3) and by way of which the primary material is able to be dispensed from the receptacle vessel (3).

9. The flow reactor (200) as claimed in claim 2, wherein the flow reactor (200) has a mixing chamber (7) which is connected to the receptacle volume (22) of the receptacle vessel (3).

10. The flow reactor (200) as claimed in claim 1, wherein the flow reactor (200) has at least one injector (5) which is connected at least indirectly to the reaction chamber (21) of the flow reactor (200).

11. The flow reactor (200) as claimed in claim 1, wherein the flow reactor (200) has at least one heating device and at least one agitating device.

12. The flow reactor (200) as claimed in claim 1, wherein the flow reactor (200) has a collection vessel (14) for a reaction product.

13. The flow reactor (200) as claimed in claim 12, wherein the flow reactor (200) has at least one throttle (26) disposed between the reaction chamber (21) and the collection vessel (14) for a reaction product.

14. The flow reactor (200) as claimed in claim 1, wherein the flow reactor (200) has at least one pressure sensor (28).

15. A flow reactor assembly (100) comprising at least one flow reactor (200) as claimed in claim 1, and a pressure source (300) for a pressurizing medium, which is connected to the pressure connector (19) of the flow reactor (200).

16. The flow reactor (200) as claimed in claim 6, wherein the pressurizing medium is selected from one or more of: compressed air, inert gas, nitrogen, oxygen, carbon dioxide, carbon monoxide and argon.

17. The flow reactor (200) as claimed in claim 9, wherein the flow reactor (200) has at least one injector (5) which is connected at least indirectly to the reactor chamber (21) of the flow reactor (200) by way of the mixing chamber (7).

18. The flow reactor (200) as claimed in claim 1, wherein the flow reactor (200) has at least one of: a magnetic agitator, a potentiostat, and a light source (30) for carrying out photochemical processes.

19. The flow reactor (200) as claimed in claim 13, wherein the at least one throttle (26) is a capillary resistance.

20. The flow reactor (200) as claimed in claim 1, wherein the flow reactor (200) has at least one pressure regulating device (27) configured to regulate pressure, at least indirectly, within at least one of the internal volume (20) and the reaction chamber (21).

21. The flow reactor assembly (100) as claimed in claim 15, wherein the pressurizing medium is selected from one or more of: compressed air, inert gas, nitrogen, and argon.

22. A method of using a flow reactor (200), the method comprising:
providing a flow reactor (200) having a pressure connector (19) by way of which an internal volume (20) of the flow reactor (200) is able to be impinged with pressure in order for a flow through a reaction chamber (21) of the flow reactor (200) to be generated, the flow reactor (200) having a receptacle vessel (3) for a primary material, receptacle volume (22) of said receptacle vessel (3), as the internal volume of the flow reactor (200), being able to be impinged with pressure in order for the flow through the reaction chamber (21) of the flow reactor (200) to be generated;
introducing a pressurizing medium, via the pressure connector (19), into the receptacle volume (22) so as to supply the primary material from the receptacle volume (22) to the reaction chamber (21).
